(19) United States
(12) Patent Application Publication
(10) Pub. No.: US 2012/0070710 A1
(43) Pub. Date: Mar. 22, 2012

(54) Sealing Frames For Use In A Battery

(75) Inventors: Peter Kritzer, Forst (DE); Olaf Nahrwold, Ludwigshafen (DE); Christoph L. Klingshirn, Eppelheim (DE)

(73) Assignee: CARL FREUDENBERG KG, Weinheim (DE)

(21) Appl. No.: 13/236,704

(22) Filed: Sep. 20, 2011

(30) Foreign Application Priority Data
Sep. 21, 2010 (EP) 10 010 035.3

(51) Int. Cl. H01M 2/10; H01M 2/30; H01M 2/08

(52) U.S. Cl. 429/100

(57) ABSTRACT

The invention concerns a sealing frame (10) for use in a battery, including a primary body (11), wherein the primary body (11) surrounds an opening (12), at least one circumferential compressible elastic seal (17), which surrounds the opening (12), wherein a trigger area (21) is provided on one edge of the opening (12), wherein a continuous deviation opening (20) is formed in the primary body (12) contiguous to the trigger area (21).

### CROSS-REFERENCE TO RELATED APPLICATIONS

This application claims the benefit and priority of European Application No. 10 010 035.3, filed Sep. 21, 2010. The entire disclosure of the above application is incorporated herein by reference.

### FIELD

The invention concerns in general sealing frames used in a battery, in particular sealing frames used for the holding and encapsulation of so-called Coffee Bag Cells. The invention furthermore concerns batteries made up of cells held between sealing frames.

### BACKGROUND

This section provides background information related to the present disclosure which is not necessarily prior art.

Larger batteries are built up of individual cells. Generally, a battery destined for a use in Hybrid or electric vehicles is made up of between approximately twenty and many hundred individual cells. It is thereby possible that these cells are arranged as button cells, prismatic cells or coffee bag cells. Coffee bag cells comprise a flexible cover made out of foil, in which the electrical components of a cell are arranged.

Coffee bag cells are used above all others, for the achievement of optimum space usage in a battery. The same are moreover indicated due to their limited weight combined with a high capacity. Coffee bag cells can readily be cooled via the thermal conductivity of the foil of the cover. Furthermore cells of this type are readily scalable insofar as all the cell components including the foil covers can be varied in size in a simple manner in production. Moreover the manufacturing of this cell type is cost-effective insofar as, among other things, it is possible to forego the expensive solid case. Accordingly such cells are especially interesting for price-sensitive applications.

Due to the sizable quantity of energy that is stored, larger batteries always represent a safety risk upon the occurrence of a malfunction. Lithium batteries are especially critical in this regard insofar as the same feature high energy density, a flammable electrolyte and thin separators. Lastly, lithium batteries generate high cell voltage, so that the components that are fitted in the cell are exposed to high electrochemical loads. This is particularly relevant for automobile and industrial batteries, for which life spans of at least 8-10 years are set, which can lead to considerable aging of the cell components.

The aforementioned coffee bag cells can be fitted in a space-saving manner. Large amounts of energy per unit of volume can thereby be stored. There are however considerable associated construction-related disadvantages. The dimensions of coffee bag cells change when they get charged or discharged, due to the flexible cover. This is also related to an expansion of the volume. The expansion of the volume brings about typical changes in thickness of an individual cell of approximately 5% when comparing the charged and discharged states.

One must consider that the individual cells will show a varying thickness in the construction of a so-called “Stack”, which is made up of numerous individual cells that are connected in line.

It must in particular be taken into consideration that the cells cause either no or only minimal pressure on the surfaces that lie next to the cells, when the cells are in their charged state, at which time they reach their thickest state. It must also fundamentally be considered that, due to manufacturing tolerances, the thickness of the flexible cells is not constant, but rather subject to variations.

In addition, there is a need for an arrangement through which shocks and vibrations can be dampened and/or cushioned, so that the inside of the battery as well as its mechanical and electrical connections (for example electrical contacts or cooling tubes) do not suffer damage. The terminals for the power and monitoring electronics should thus be connected to the battery without any mechanical burden. In the case of series connection, the uncoupling of even one of the many hundred contacts of the power electronics leads to the failure of the battery. With the failure of one contact of the monitoring electronics, the no longer monitored cells can gradually reach a critical condition, which in the medium term can lead to the damage or failure of the whole battery.

Furthermore, the coolant medium can leak into the inside of the battery in the event of a rupture of a cooling line. Depending on the type of cooling system (for example an air conditioning system), it is possible that one is dealing with a cooling medium that could be inflammable, or gaseous substances that can be ignited upon contact with current-carrying parts.

The edges of the aforementioned coffee bag cells feature a circumferential seam seal. This seam seal connects two foil layers of one cell, which creates the cover. The active components of the cell are then enclosed in the thus created void. These foils are coated on the inner side with an insulating, bond-promoting sealing thermoplastic.

This sealing thermoplastic can be created out of a functionalized polyolefin.

The seam seal represents a mechanical weak point of a coffee bag cell. The air pressure can fluctuate in the surroundings of the cells. When the housing of a battery is hermetically sealed, it can lead to temperature dependent pressure fluctuations of typically 0.2 bars. These fluctuations of the pressure further stress the seam seal. The seam seal also constitutes a pre-determined breaking point, which should allow the electrolyte to be purged, in the event of a malfunction of the battery. A rupture of the cover of the cells should hereby be averted.

Beyond this, the cells are frequently exposed to considerable temperature fluctuations. In the case of automobile batteries, one typically assumes extremes going from −30° C. up to 70° C.

When the inflammable electrolyte or organic decomposition gases that occur in the event of a battery failure come into contact with electrodes, they can possibly ignite and lead to fires or explosions. The maximum allowable overpressure on the inside of a coffee bag cell generally lies well below 1 bar, so as to prevent the bursting of a seam seal. It is especially critical to consider the execution of the electrodes used to discharge the current in coffee bag cells. These generally feature thicknesses of approximately 0.1 to 0.3 mm. Possible leakage in this area is also especially critical insofar as it is possible that purged electrolyte can spontaneously ignite on the electrodes. The seam seal is generally seen as being the weak point of large cells insofar as they are continuously exposed, over the years, to loads brought about by cycling.

Even when measures are foreseen whereby, in the event of a failure, the electrolyte or the organic decomposition gases are purged at a specific point of the seam seal so as to avoid that the purged electrolyte comes into contact with the electrodes, there nonetheless remains the difficulty of leading away the purged electrolyte from the battery. It must be dependably ensured, in particular in motor vehicle applications, that the purged electrolyte does not reach the interior of the vehicle. Traditional measures that are used for the collection of electrolyte that is purged during the case of a failure are complex and require additional installation work, whereby a separate purge channel for the electrolyte is fitted to the battery housing.

### SUMMARY

This section provides a general summary of the disclosure, and is not a comprehensive disclosure of its full scope or all of its features.

The purpose of the present disclosure is that of foreseeing, in the case of a battery built up of separate individual cells, that it is possible to achieve a deviation of the purged electrolyte occurring in the event of a failure with a possibly limited amount of assembly work.

The use of a sealing frame in a battery is foreseen according to one first feature. The sealing frame comprises a primary body, which encompasses an opening and at least one surrounding elastic compressible seal, that surrounds the opening, whereby a trigger area is foreseen on one edge of the opening to exert minimal or no contact pressure upon an element that is laid out on the sealing frame, wherein there is a permeable purge opening in the primary body that is set out adjacent to the trigger area.

The sealing frame for the construction of a battery with, for example, the so-called coffee bag cells includes a surrounding seal to hold a cell, whereby a trigger area is foreseen in which the sealing surface exerts minimal or no contact pressure on the seam seal of the cell to create a targeted purge point. A deviation opening is connected to the trigger area of the targeted purge point, which is used to lay out a deviation channel for the electrolyte that is purged through the trigger area made up of the sequential serial lay-out of multiple sealing frames.

The provision of the deviation channel makes it possible to accomplish the building of a stack of battery cells in an especially simple manner while contemporaneously creating the deviation channel for the purging of electrolyte in the case of failures. It is thereby not necessary to feature an additional element on the battery, such as for example a purge cap or similar, which would cover the targeted purge point, but rather it solely requires that there be one single opening to be used as connector to the deviation channel. The deviation channel can thereby be created in a dependable manner, insofar as no additional construction elements need to be fitted to the housing of the battery.

Furthermore the seal can surround the deviation opening. It is thereby possible to use a seal that is in itself self-contained, which encircles both the opening as well as the deviation opening. Insofar as the seal does not feature any end piece, the danger of a leak brought about by the flexing of one end of the seal, or from an area that is not sealed by the seal, is reduced.

According to one embodiment, the seal can be foreseen as a sealant strip or as a seal area which shuts off flush with one border of the opening at least outside of the trigger area.

It is possible to foresee bores in the sealing frame to form a channel for a coolant or heating media. In such a case it is possible to fit the bores themselves with seals and thereby create the channel. Alternatively it is possible to feed tubing through the bores for coolant/heating media or alternatively cables for electrical heating.

The primary body can be produced out of a compressible elastic material, where in particular the seal is created integrally with the primary body.

Furthermore the seal can be produced as a compressible elastic layer that is applied to the non-elastic primary body.

It can be foreseen that the trigger area of the primary body is created through a depression of one edge of the opening in the primary body.

The edge of the primary body can be formed in the trigger area by a bridge, which is arranged in such a manner that it creates a double-sided depression of one edge of the opening in the primary body.

It is possible according to a further embodiment to create the edge of the primary body in the trigger area by means of a bridge that is set out in such a manner that it creates a double-sided depression of one edge of the opening in the primary body. The bridge has the purpose of stiffening the primary body of the sealing frame in the area of the deviation opening, in such a manner to achieve a greater stability of the shape.

The bridge can be located between the deviation opening and the opening.

According to a further feature, the placement of the aforementioned sealing frame and a cell, in particular a coffee bag cell, is foreseen, wherein the cell features a cell housing that is surrounded by a seam seal, wherein the cell can be applied to the sealing frame in such a manner that the cell housing reaches into the opening, the seam seal lays against the seal and the seam seal is not generally impinged by the seal in the trigger area.

According to a further feature a battery is foreseen. The battery includes at least two of the aforementioned sealing frames and at least one cell, which is positioned between two sealing frames, wherein the cells feature a cell housing, which is surrounded by a seam seal, wherein the cell housing extends in the openings of the primary body of the sealing frames and wherein the seam seal is incorporated by contract pressure between the seal of the sealing frame and a primary body of a further sealing frame or between the seals of two opposing sealing frames, wherein the seam seal is not generally impinged by the seal in the trigger area.

Furthermore it is possible to fit discharge terminals, which extend beyond the sealing frames, between the sealing frames.

Furthermore the battery can be assembled through the alternate stacking of the sealing frames and the cells, whereby on at least one end of the battery in the stacking direction there is an end plate which is used to close the interior space created by the openings of the sealing frames, wherein the end plate features a connector element for the connection of a discharge conduit for the discharge of the electrolyte that has been purged by the cells, which corresponds to a deviation channel that is created by the deviation openings.

The use of the aforementioned sealing frames for the construction of a battery with one or more cells is foreseen according to a further feature.

Further areas of applicability will become apparent from the description provided herein. The description and specific examples in this summary are intended for purposes of illustration only and are not intended to limit the scope of the present disclosure.

### DRAWINGS

The preferred embodiments are described in more detail here below on the basis of the attached drawings. It shows:

FIGS. 1 and 1a are schematic depictions of a coffee bag cell in a plan view and in a side view, respectively;

FIG. 2 is a plan view of a sealing frame with a surrounding elastic seal;

FIG. 3 is a perspective view of the sealing frame of FIG. 2;

FIG. 4 is a sealing frame with seals fitted to both sides and applied coffee bag cell; and

FIG. 5 is a perspective view of a battery that is made up of the combination of multiple coffee bag cells and sealing frames with the deviation channel for the electrolyte that is purged in the case of failure.

Corresponding reference numerals indicate corresponding parts throughout the several views of the drawings.

### DETAILED DESCRIPTION

Example embodiments will now be described more fully with reference to the accompanying drawings.

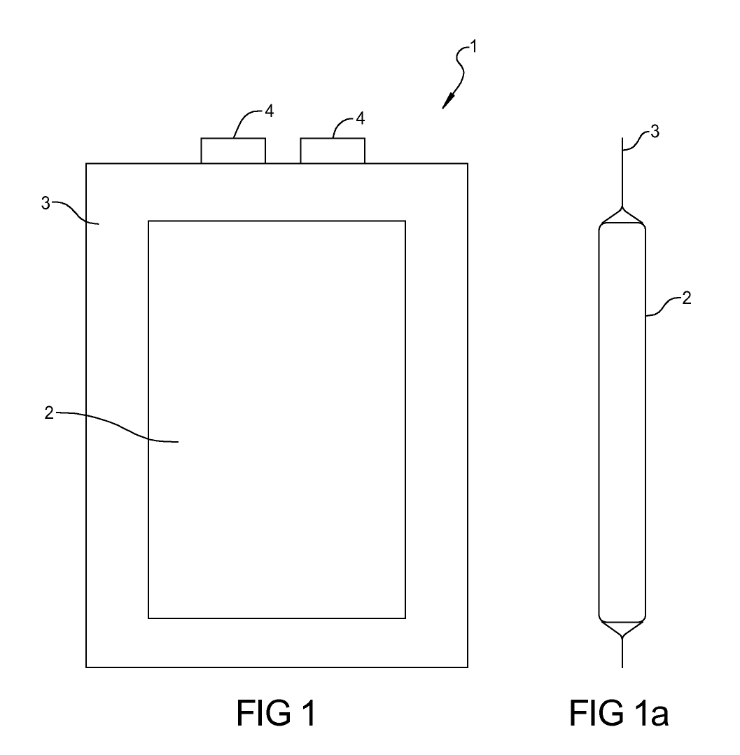

FIGS. 1 and 1a depict a galvanic cell 1 in a plan view as well as in a side view. The galvanic cell 1 is depicted as a coffee bag cell. The inside of the cell 1 is found in the cell housing 2. The cell housing 2 is made up of two layers of sheet metal, which are in particular polyolefin-coated aluminum foil. The electrode/separator stack, which generates the electrical voltage, is located on the inside of the cell 1.

The cell housing 2 features a surrounding seam seal 3 on its edge, at which point the two coated sheet metal pieces are laminated with one another, which hermetically seals the inside of the cell 1. Discharge terminals 4 stick out of the seam seal 3, through which it is possible to tap the electrical voltage. Traditional cells for automobile batteries or industrial back-up batteries generally feature a cell housing of one 1 cm and a length and width of more than 20 cm. The width of the seam seal of such cells is generally approximately 1 cm and the thickness approximately 1-2 cm.

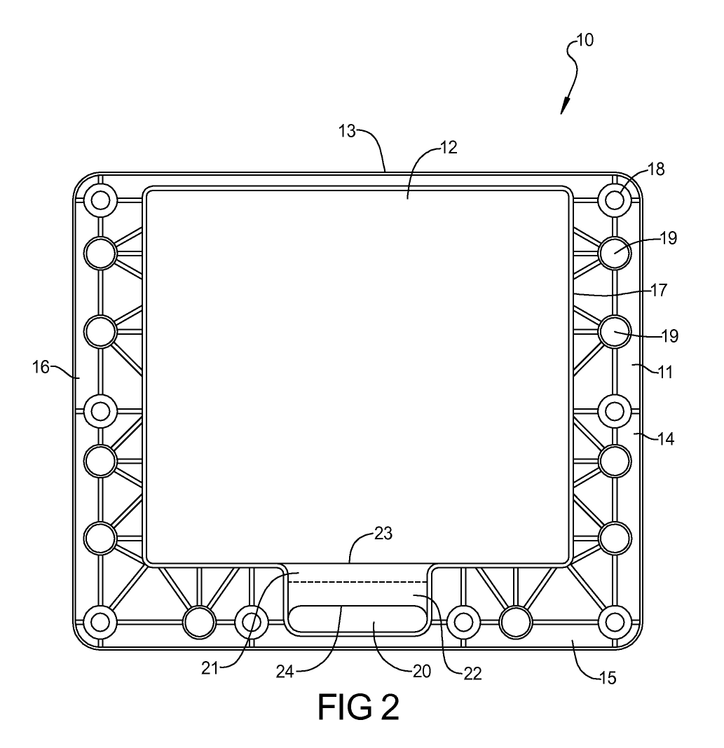

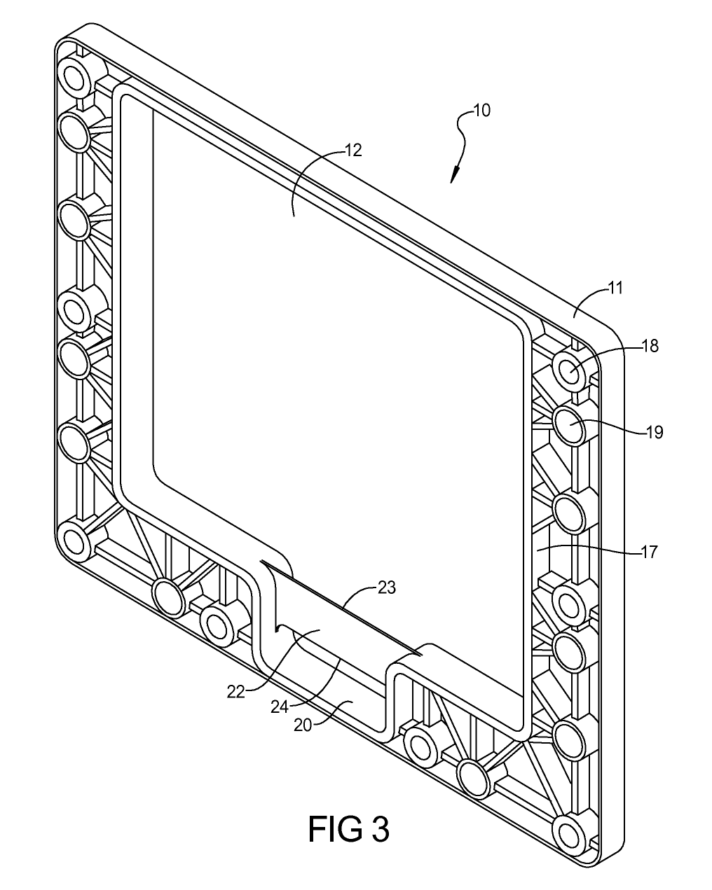

FIG. 2 depicts a plan view of a sealing frame 10 for the construction of a battery having one or more cells 1, as they are for example depicted in conjunction with FIG. 1. The sealing frame 10 is shown in a perspective view in FIG. 3.

The sealing frame 10 comprises a primary body 11 that encompasses a passing opening 12. The primary body 11 and the opening 12 are sized according to the cell 1 that is to be fitted or held, namely in such a way that the cell housing 2 of the cell 1 fits into the opening 12 and the primary body 11 lays up to the seam seal 3.

The primary body 11 can generally be arranged in a square shape and feature four laterals 13, 14, 15, 16, which are thus arranged in right angles to one another. The material used for the primary body can generally be selected as desired, for example using synthetic material or metal. Synthetic material can be recommended as the material for the primary body 11 on the basis of the limited weight and the simple production. It is advantageous to use a thermal conductive synthetic material, through which the heat transfer between the cell surface and the coolant/heating channel can be improved. It can be envisaged that lightweight construction materials such as composites or closed pore foams, which can contribute to weight savings of the whole system, can be used.

The use of materials that are self-extinguishing and thus do not ignite upon contact with the purged, possibly hot, gases is furthermore advantageous. In this case, for example, the use of polyamides with a high percentage of glass fiber can be envisaged.

The primary body 11 features a surrounding seal 17, that can be laid out as a sealant strip or as a sealing surface. The seal 17 works as a contact pressure area that exerts a load on the seam seal 3 of the cell 1. The seal 17 is preferably, but however not necessarily, aligned with the edge of the opening 12, so as to possibly avert that a variation in the geometry of cell 1 that occurs during charging does not bring about contact between the cell housing 2 with an internal edge of the primary body 11. Friction between the primary body 11 and the cell housing 2, which can lead to increased wear and tear and potentially to the occurrence of leakage in the area of the sheet metal that creates the cell housing 2, can thereby be prevented.

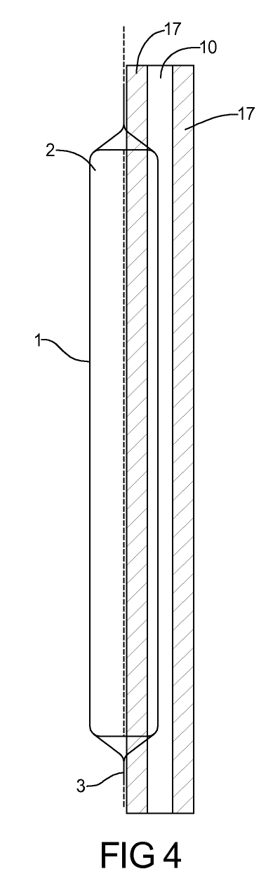

A number of the aforementioned sealing frames 10 are stacked upon one another to build a battery, wherein a cell 1 is inserted between each two sealing frames 10, in such a manner that the cell housing 2 fits inside the respective opening 12 of both sealing frames 10 and the seam seal 3 is held by the seal 17 that is fitted to the laterals 13, 14, 15, 16 of the primary body 11. The arrangement of the cell 1 relative to the sealing frame 10 is schematically depicted in FIG. 4.

The sealing frames 10 can be mounted to one another, for example by means of screws and/or bolts that pass through the perforations 18 and that exert contact pressure on the seam seal 3 that is respectively found between two sealing frames 10. This provides that the cell 1 is reliably held by the seam seal 3 and at the same time an additional load is placed upon the area of the seam seal 3 that is in contact with the seal 17, in such a manner that there is an increased tightness there upon the occurrence of an increased pressure on the inside of the cell housing 2, for example in the case of a failure. The perforations 18 are preferably equally distributed in the primary body 11, so as to exert a uniform contact pressure and in particular largely ensure that a minimum contact pressure is assured. It can alternatively be envisaged that the sealing frames can be mounted in the stack by means of clamps.

One of the laterals 13 of the primary body 11 is built up with a reduced width (in the direction of the extension that is at right angles to the laterals 14, 16) and preferably constitutes the side of the primary body 11, through which the electrodes 4 of the cell 1 exits the battery which is built up with the sealing frames 10. The reduced width of the lateral 13 is thereby selected so as to ensure that the section of the seal 17 that lies thereupon nonetheless exerts a sufficiently high contact pressure on the seam seal 3.

So as to be able to build up batteries with multiple cells 1, it is preferably foreseen that the primary body 11 of the sealing frame 10 is fitted with seals 17 on both sides. In this case, the seals 17 lie opposite one another in relation to the primary bodies 11 and preferably lie flush to the edge of the opening 12.

It can of course be envisaged that there only be a single-sided seal, wherein an elastic connection only takes place on one side of the seam seal. Such an embodiment has the advantage of a more cost effective production of the sealing frames as well as, where applicable, a better thermal connection of the cell, in the case where the thermal conductivity of the material of the sealing frame is greater than that of the seal. The build-up of the battery then takes place through the stacking of the sealing frames, in such a manner that one side of the sealing frame, which is fitted with a seal, is installed on the side of the sealing frame without the seal.

The primary body 11 is furthermore sized in such a manner that the same extends beyond the seam seal 3 of the cell 1. An additional seal to protect against atmospheric humidity beyond that of the contact pressure on the seam seal 3 can be provided for, when two neighboring sealing frames 10 lie immediately next to one another in the area extending beyond the seam seal 3. It can also be envisaged that the sealing frames 10 can interlock with one another by way of their shape.

The thickness of the primary body 11 is generally determined by the thickness of the cell housing 2 in charged condition, which is to say in the condition of maximum expansion of the cell housing, in such a manner that the cells do not exert any pressure on one another in a battery built up of multiple cells 1 that are attached one to another. Such pressure could lead to an undesired crosswise or tensile loading of the seam seal 3. The thickness of the primary body 11 is initially at least as large as the charged cell.

Furthermore there are bores 19 in the primary body 11, which in the stacked state of the battery with multiple sealing frames 10 stacked up one upon another create a channel to conduct coolant or heating fluid. It is thereby possible to achieve a regulation of the temperature of the aforementioned battery that is built up with the sealing frames 10. The bores 19 feature an axial length that corresponds to the thickness of the sealing frames 10. As an alternative, it is possible to foresee conduit tubing in the bores 19, through which the coolant or heating fluid will flow.

The primary body 11 of the sealing frame 10 is preferably made up of a solid material, such as for example metal or synthetic material. The material should exhibit a sufficient rigidity to ensure that, in the area between the perforations 18, which are used to connect the sealing frames 10 over the seals 17, with one another, there is sufficient contact pressure on the seam seal 3.

The primary body and the seal are created as an integral piece in an alternative embodiment of the sealing frames, wherein the sealing frames are made up of a compressible elastic material.

The primary body 11 can be created out of solid material, or the inner edge of the opening 12 and the outer side of the primary body 11 can both feature the same thickness of the primary body 11, wherein the inner edge of the opening 12 and the outer side of the primary body 11 are joined together by means of bridges, between which depressions are foreseen, which is done to possibly minimize the weight of the thus created sealing frame 10. The perforations 18 and the bores 19 can also be joined with the inner edge of the opening 12 and/or the outer side of the primary body 11, so as to precisely lay out their position in the sealing frame.

There is a deviation opening 20 that is foreseen on one of the laterals 13, 14, 15, 16 that is adjacent to the opening 12 that accepts the cell housing 2, preferably on the lateral 15 which lies opposite to the lateral 13 having the reduced width. It is necessary that stacking of the cells be considered herein, so that for example the purging of the electrolyte is not hindered by the arrangement of the electrodes and separators within the inside of the cell. The deviation opening 20 represents a perforation through the primary body 11 that creates the deviation opening 20 upon the stacking on one another of multiple frame seals 10.

When mounted, the deviation opening 20 in correspondence with the trigger area 21 of the seam seal 3 of the cell 1, where no or a noticeably reduced contact pressure is exerted by the seal 17 on the seam seal 3. The trigger area 21 creates a targeted purge point for the cell 1, in such a manner that upon occurrence of a failure which leads to an increase in the pressure on the inside of the cell housing 2, the seam seal 3 will be ripped open and the electrolyte that is found on the inside of the cell housing will be purged in the area of the deviation opening 20.

To ensure that there is sufficient sealing of the deviation channel that is created by the stacking upon one another of the deviation openings 20 of the sealing frames 10, it can be foreseen that the seal 17 is made to encircle not only the opening 12 but also the deviation opening 20. It is thereby possible to make the seal as a single integral part, wherein one can achieve an increased level of dependability through the sealing of the internal space of the battery that is created by the opening 12 and the deviation opening 20.

The deviation opening 20 can be provided with a bulge to the edge of the opening 12 down to the outer edge of the primary body 11 in the area neighboring the trigger area 21. In this case, the opening 12 almost overflows into the deviation opening 20. It is possible to locate a bridge 22 that features a lesser thickness than that of the primary body 11, inside the bulge that is created by the deviation opening that is adjacent to the trigger area. The bridge 22 can preferably be centered with respect to the thickness of the primary body 11. The bridge is primarily meant to provide the mechanical stabilization of the primary body 11 and for this purpose can feature a first edge 23, which is basically a lengthening of the inner edge of the opening 12 on the wider lateral 15. One of the second edges 24 that lies opposite to the first edge of the bridge 22 basically creates a limitation of the deviation channel that is created by the deviation openings 20.

It is possible to provide an area of the inner wall or the entire inner wall of the deviation opening 20 with a thermal resistant protection layer, to avoid damage to or influence of the primary body 11 brought on by the purging electrolyte, which can exhibit a high temperature in the case of a failure. It is preferable that the protective layer is provided for in the area of the inner wall of the deviation opening 20 that is opposite to the opening 11. The purging electrolyte can thereby come in contact with the protective layer and the thermal effect on the primary body is reduced.

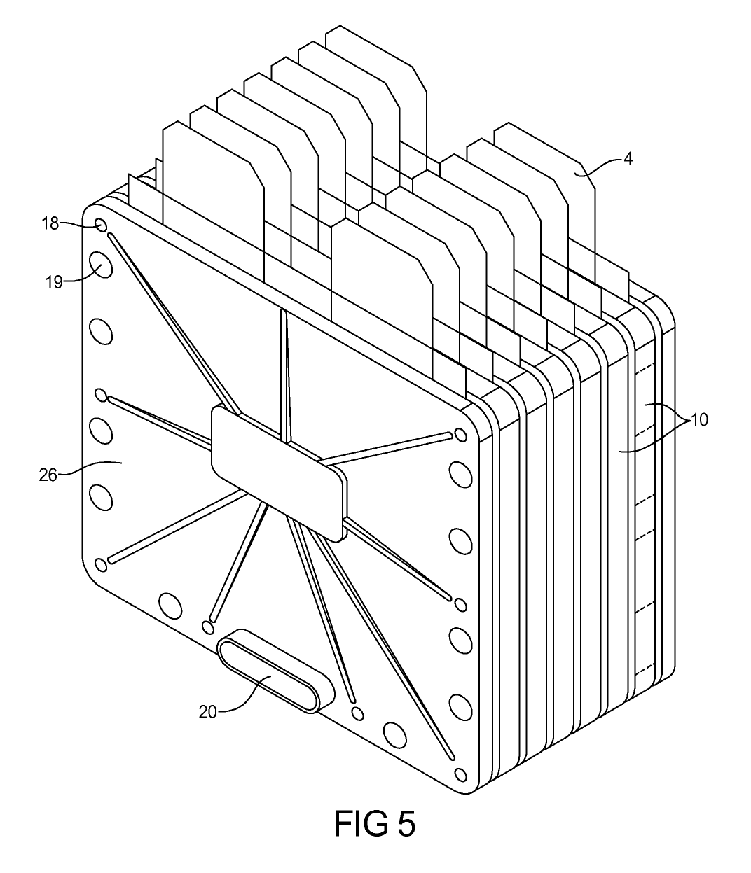

In FIG. 5 there is a perspective representation of a battery that is assembled out of multiple sealing frames 10 and cells 1. One can recognize the sandwich structure in which one cell 1 is respectively placed between two adjacent sealing frames 10. Furthermore the sealing frames 10 are assembled to one another in such a way that the deviation openings 20 create a deviation channel that is adjacent to the trigger area 21. End plates 25 that are stacked with the sealing frames 10 are foreseen to protect the face of the thus assembled battery, as well as access to the bores 19 for the pass through of the coolant or alternatively heating medium, and a connection nozzle 26 for the attachment of a (not depicted) outlet conduit from the deviation channel which can enable the drainage of eventual purged electrolyte to a desired location.

It is possible to arrange compressible thermal conduction components between the individual cells, such as for example porous non-woven fabrics or foamy materials that contain thermal conduction components, coated non-woven fabrics/foams, non-woven fabrics or foams that are overlaid/bound with metal and similar. One can envisage as an alternative to insert a film-heating-foil between the cells, which is, for example, glued onto the top surface of the cells or else is pressed onto the top surface by a compressible element.

One can furthermore envisage fitting a valve on the connection nozzle 26 or alternatively in the outlet conduit, which ensures that the battery is sealed towards the outside in normal operating conditions but opens under the electrolyte being purged which occurs through high internal over-pressure.

### LEGEND

1 Cell

2 Cell housing

3 Seam seal

4 Discharge terminals

10 Sealing frame

11 Primary body

12 Opening

13, 14, 15, 16 Lateral

17 Seal

18 Perforations

19 Bores

20 Deviation opening

21 Trigger area

22 Bridge

23 First edge

24 Second edge

25 End plate

26 Nozzle

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A sealing frame (10) for use in a battery, comprising:
a primary body (11), wherein the primary body (11) surrounds an opening (12),
at least one circumferential compressible elastic seal (17), which surrounds the opening (12),
wherein a trigger area (21) is foreseen on one edge of the opening (12),
wherein a pass-through deviation opening (20) is provided in the primary body (12) adjacent to the trigger area (21).

2. The sealing frame (10) according to claim 1, wherein the seal (17) encloses the deviation opening (20).

3. The sealing frame (10) according to claim 1, wherein the seal (17) is a seal area that shuts off flush with one side of the opening (12) at least outside of the trigger area (21).

4. The sealing frame (10) according to claim 1, wherein bores are disposed in the primary body (11), so as to create a coolant or heating material channel.

5. The sealing frame (10) according to claim 1, wherein the primary body (2) is produced from a compressible elastic material.

6. The sealing frame (10) according to claim 1, wherein the seal (17) is created as a compressible elastic layer, which is fitted to the non-elastic primary body (11).

7. The sealing frame (10) according to claim 1, wherein the trigger area (21) of the primary body (11) is formed through a depression of one edge of the opening (12) in the primary body (11).

8. The sealing frame (10) according to claim 1, wherein the edge of the primary body is formed through a bridge (22) in the trigger area (21), that is arranged in such a manner to form a double-sided depression of one edge of the opening (12) in the primary body (11).

9. The sealing frame (10) according to claim 1, wherein the edge of the primary body (11) is formed by means of a bridge (22) in the trigger area (21), that is arranged in such a manner to form a double-sided depression of one edge of the opening (12) in the primary body (11).

10. The sealing frame (10) according to claim 9, wherein the bridge (22) is arranged between the deviation opening (20) and the opening (12).

11. A battery, comprising at least two sealing frames (10) comprising:
a primary body (11), wherein the primary body (11) surrounds an opening (12),
at least one circumferential compressible elastic seal (17), which surrounds the opening (12),
wherein a trigger area (21) is foreseen on one edge of the opening (12),
wherein a pass-through deviation opening (20) is provided in the primary body (12) adjacent to the trigger area (21), and
at least one cell (1) wherein the cell (1) is positioned between two sealing frames (10), wherein the cells (1) feature a cell housing (2) which is surrounded by a seam seal (3), wherein the cell housing (2) extends in the opening (12) of the primary body (11) of the sealing frame (10) and wherein the seam seal (3) is taken up with contact pressure between the seal (17) of one sealing frame (10) and the primary body (11) of a further sealing frame (10) or between the opposing seals (17) of two sealing frames (10), wherein the seam seal (3) is not contacted by the seal (17) in the trigger area.

12. The battery according to claim 11, wherein discharge terminals of the cell are fitted between the sealing frames (10), which extend beyond the sealing frame (10).

13. The battery according to claim 11, wherein the battery is built up through the alternating stacking of sealing frames (10) and cells (1), wherein on at least one end of the stacking direction there is an end plate (25) that is fitted to close off the void that is created by the openings (12) of the sealing frames (10), wherein the end plate (25) features a connection element that is connected to the deviation channel that is created by the deviation openings.
